(19) United States
(12) Patent Application Publication
(10) Pub. No.: US 2005/0003764 A1
(43) Pub. Date: Jan. 6, 2005

(54) Current control circuit

(75) Inventors: Michael D. Piorun, Citrus Heights, CA (US); Chinnugounder Senthilkumar, Folsom, CA (US); Robert Fulton, Folsom, CA (US); Kirupa Pushparai, Orangevale, CA (US); Andrew M. Volk, Granite Bay, CA (US)

Correspondence Address: SCHWEGMAN, LUNDBERG, WOESSNER & KLUTH, P.A., P.O. BOX 2938, MINNEAPOLIS, MN, 55402, US

(73) Assignee: Intel Corporation

(21) Appl. No.: 10/465,476

(22) Filed: Jun. 18, 2003

(51) Int. Cl. H04B 1/16; H04B 1/06; H04B 7/00

(52) U.S. Cl. 455/67.11; 455/515; 455/195.1; 455/255

(57) ABSTRACT

An apparatus, in some embodiments, includes a first circuit to monitor a current, a second circuit to produce a reference current, and a control circuit coupled to the first circuit and the second circuit. In operation, the control circuit processes a first signal received from the first circuit and a second signal received from the second circuit and provides a control signal to the circuit to control the current. A method, in some embodiments, includes generating a reference current, generating a first current in a circuit, generating a second current related to the first current, and reducing the first current when the second current is greater than the reference current.

### FIELD

This present invention relates to a control system. More particularly, the present invention relates to a control system for controlling currents in an electronic system.

### BACKGROUND

Currents in some electronic systems can take on values outside the specified operating range for the currents in the systems. An operating range is sometimes specified to avoid premature degradation of a system, or in some cases, catastrophic failure of the system. For inexpensive systems, a correction after failure of the system only requires replacement of an inexpensive component. However, for complex systems, such as computer systems, or warranted systems, failure of the system can be expensive for a manufacturer to correct. Many designs have been suggested in the past to confine the currents to the specified operating ranges in a system. These designs are cumbersome, often requiring the purchase and assembly of many extra electronic components, and expensive.

### BRIEF DESCRIPTION OF THE DRAWINGS

FIG. 1A is a block diagram of an apparatus including a monitor circuit, a reference circuit, and a control circuit for controlling a current signal in a circuit in accordance with some embodiments of the present invention.

FIG. 1B is a timing diagram illustrating the relationship among the current signal, the monitor circuit output signal, the reference circuit output signal, and the control signal shown in FIG. 1A in accordance with some embodiments of the present invention.

FIG. 1C is a block diagram of the apparatus shown in FIG. 1A including a block diagram of the circuit and a schematic diagram of the monitor circuit, the reference circuit, and the control circuit in accordance with some embodiments of the present invention.

FIG. 1D is a block diagram of the current reference circuit, shown in FIG. 1C, in accordance with some embodiments of the present invention.

FIG. 1E is a set of equations for calculating a value of a difference current signal in the current reference circuit shown in FIG. 1D.

FIG. 1F is a block diagram of the circuit shown in FIG. 1A and FIG. 1C in accordance with some embodiments of the present invention.

FIG. 1G is a schematic diagram of the voltage regulator, shown in a block diagram in FIG. 1F, coupled to the connective element in accordance with some embodiments of the present invention.

FIG. 1H is a block diagram of a system including the apparatus, shown in FIG. 1A, including the circuit shown in FIG. 1A, in accordance with some embodiments of the present invention.

FIG. 1I is a flow diagram of a method for controlling a current in accordance with some embodiments of the present invention.

### DESCRIPTION

In the following description of some embodiments of the invention, reference is made to the accompanying drawings which form a part hereof, and in which are shown, by way of illustration, specific embodiments of the invention which may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention. The following description is not to be taken in a limiting sense, and the scope of the present invention is defined only by the appended claims, along with the full scope of equivalents to which such claims are entitled.

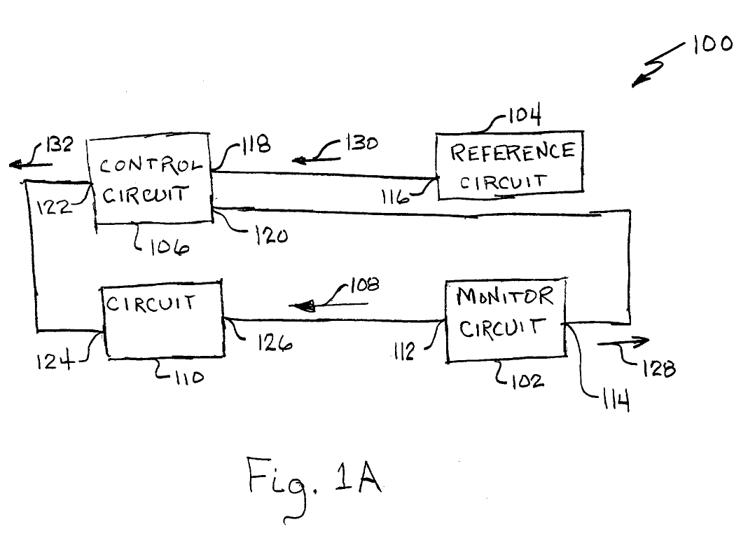

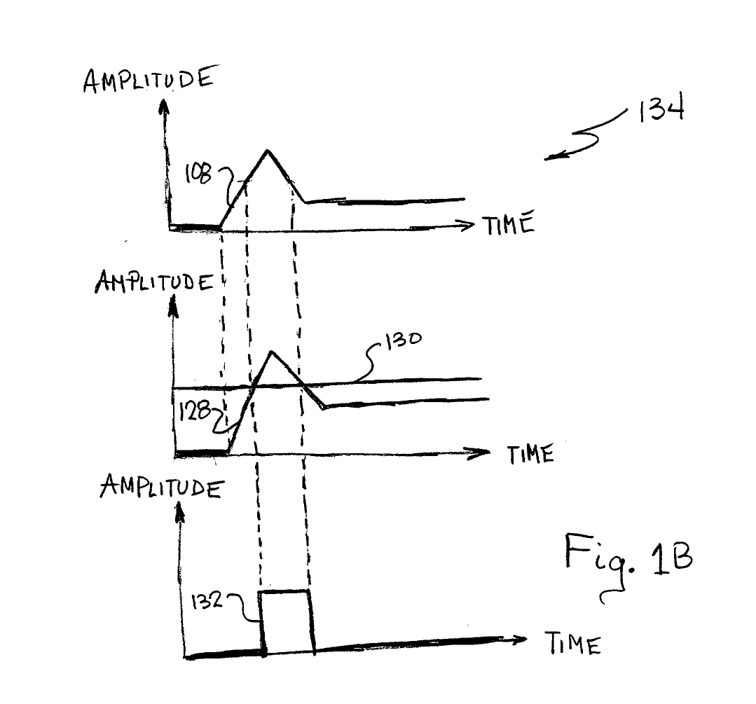

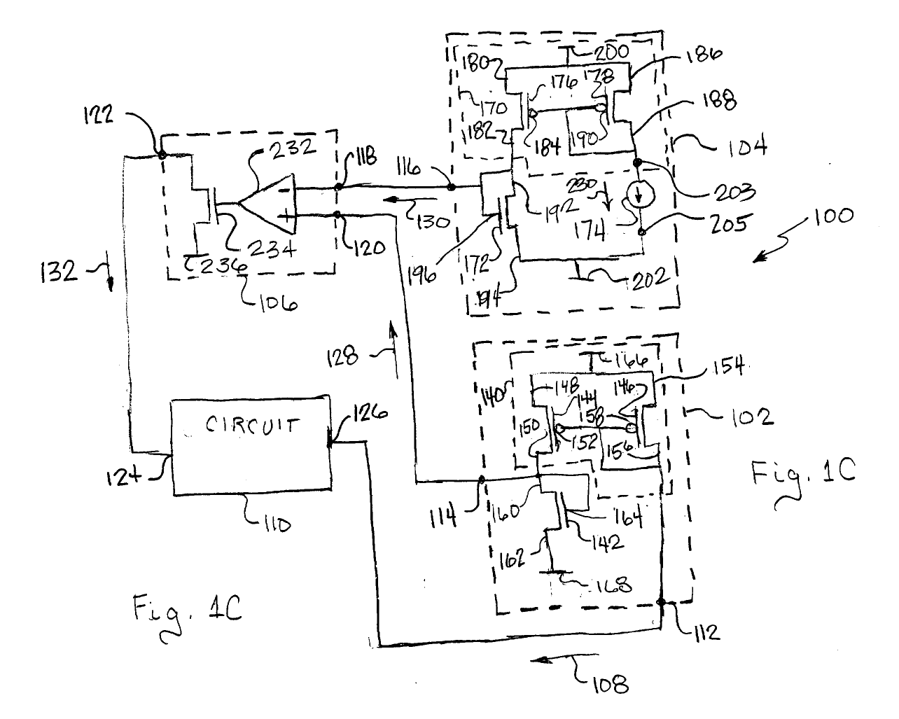

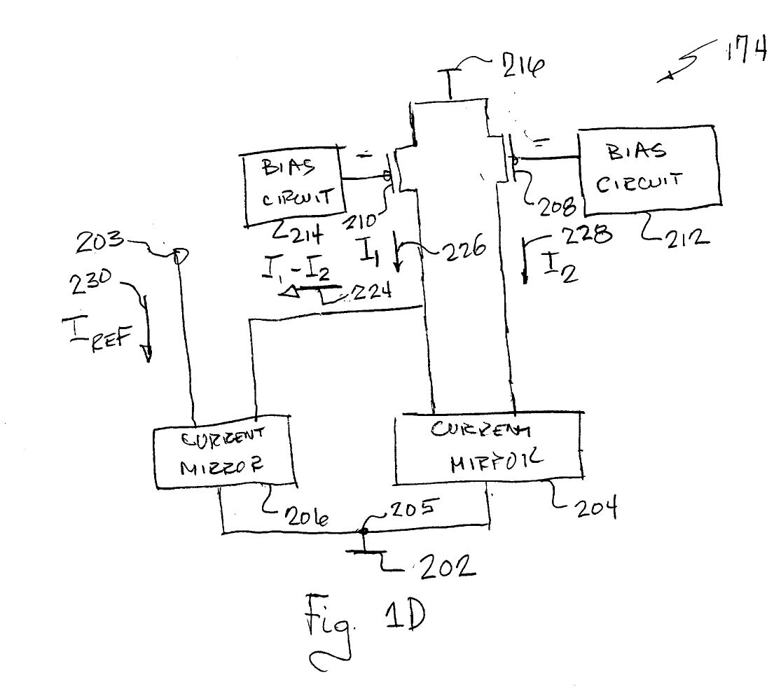

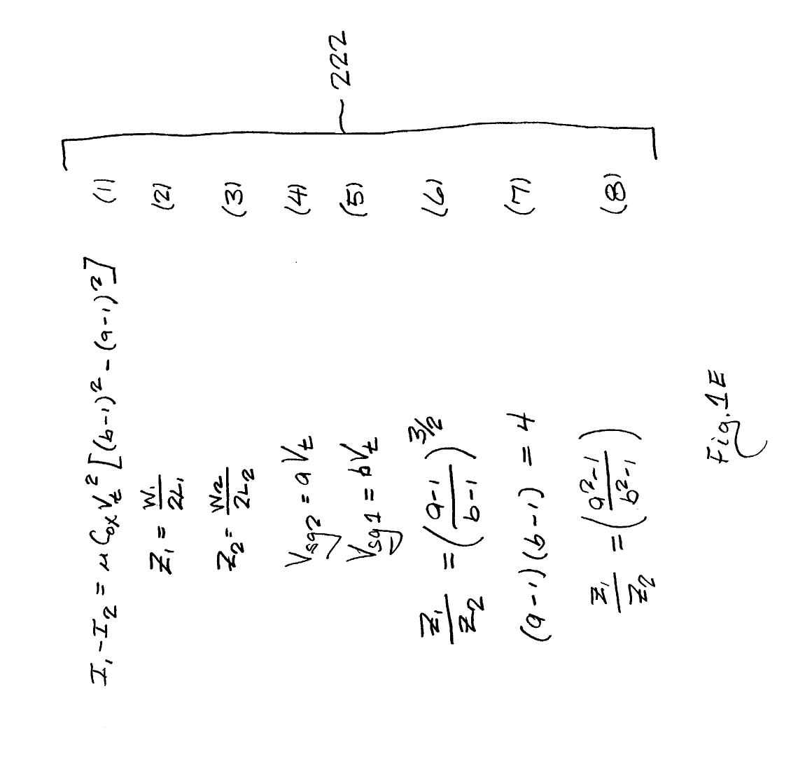

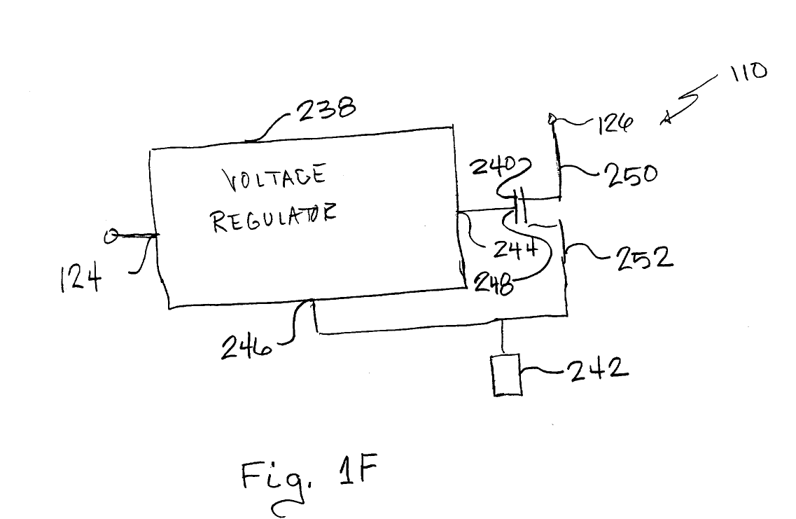

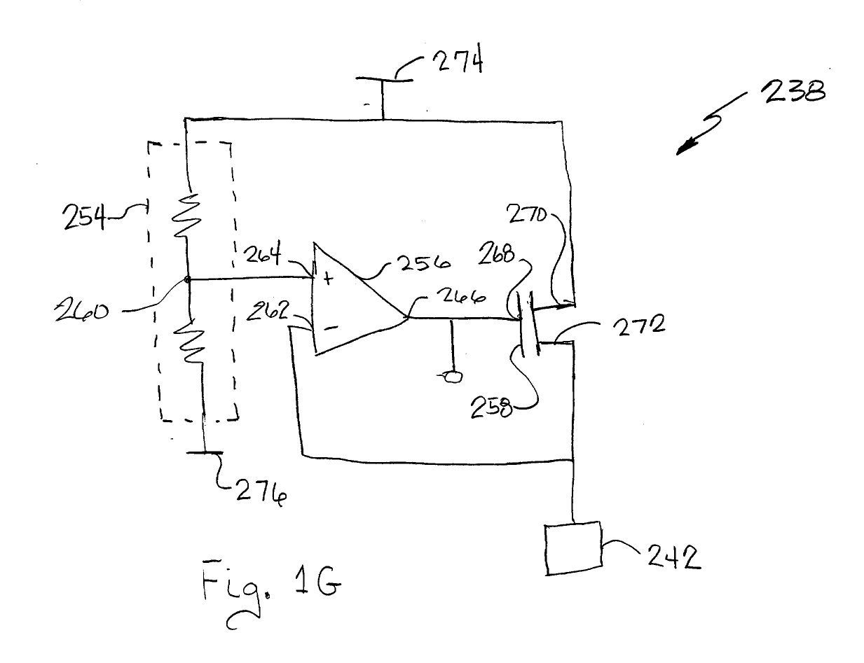

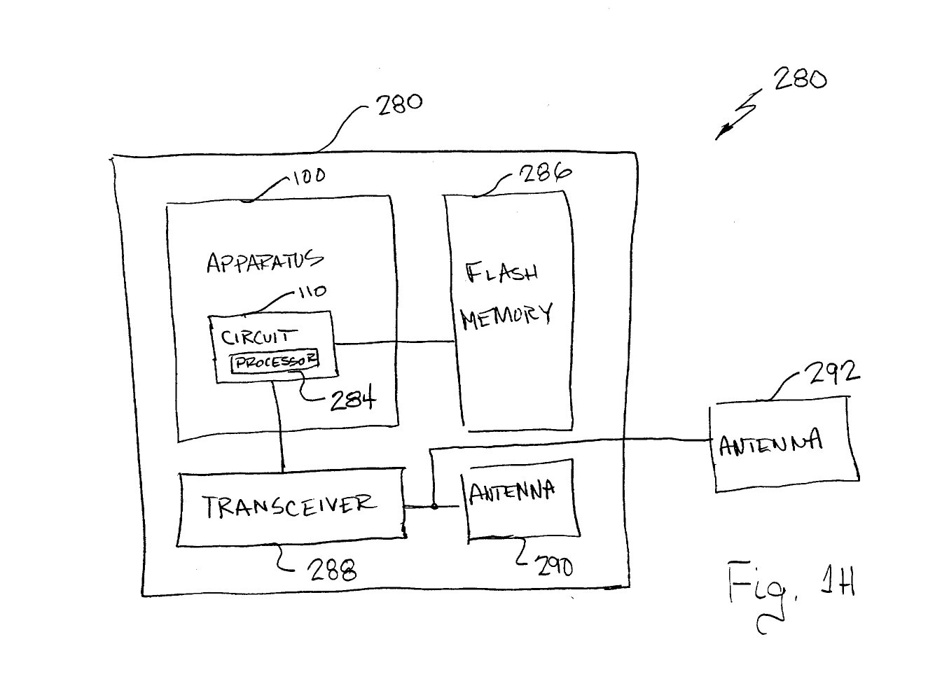

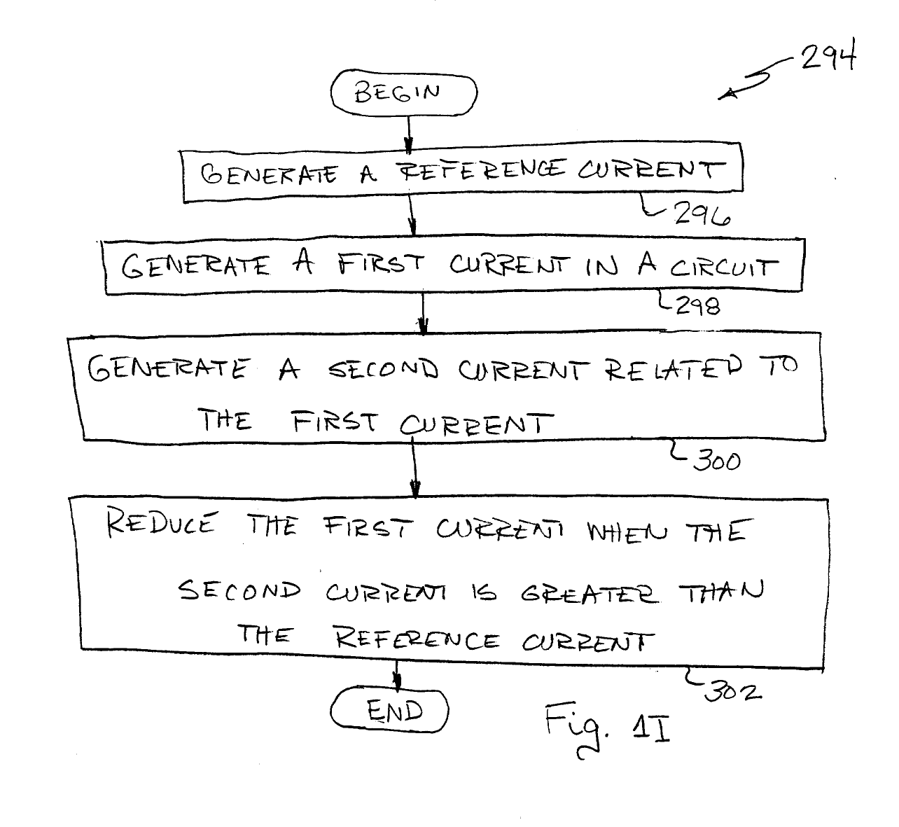

FIG. 1A is a block diagram of an apparatus 100 including a monitor circuit 102, a reference circuit 104, and a control circuit 106 for controlling a current signal 108 in a circuit 110 in accordance with some embodiments of the present invention. The monitor circuit 102 includes a signal port 112 and an output port 114. The reference circuit 104 includes an output port 116. The control circuit 106 includes input ports 118 and 120 and an output port 122. The circuit 110 includes a control port 124 and a signal port 126. The signal port 112 of the monitor circuit 102 is coupled to the signal port 126 of the circuit 110. The input ports 118 and 120 of the control circuit 106 are coupled to the output port 116 of the reference circuit 104 and the output port 114 of the monitor circuit 102, respectively. The control port 124 of the circuit 110 is coupled to the output port 122 of the control circuit 106.

In operation, the current signal 108 is present at the signal port 112 of the monitor circuit 102 and at the signal port 126 of the circuit 110. In response to the current signal 108, the monitor circuit 102 generates a monitor control signal 128 at the output port 114. The monitor control signal 128 is substantially proportional to the current signal 108. The reference circuit 104 generates a reference signal 130 at the output port 116. The control circuit 106 receives the monitor control signal 128 at the input port 120 and the reference signal 130 at the input port 118. The control circuit 106 processes the monitor control signal 128 and the reference signal 130 to generate a control signal 132 at the output port 122. The control signal 132 is active when the monitor control signal 128 is greater than the reference signal 130 and inactive when the monitor control signal 128 is less than the reference signal 130. The circuit 110 receives the control signal 132 at the control port 124. The control signal 132 reduces the current signal 108 in the circuit 110, if the monitor control signal 128 is greater than the reference signal 130. In some embodiments, the monitor control signal 128 reduces the current signal 108 to substantially zero.

FIG. 1B is a timing diagram 134 illustrating the relationship among the current signal 108, the monitor control signal 128, the reference signal 130, and the control signal 132 shown in FIG. 1A in accordance with some embodiments of the present invention. To show the relative relationship between the amplitude of the reference signal 130 and the amplitude of the monitor control signal 128, the reference signal 130 and the monitor control signal 128 are shown on the same amplitude/time diagram. As can be seen in the timing diagram 134, the monitor control signal 128 substantially tracks the current signal 108. As the current signal 108 increases, the monitor control signal 128 increases. As the monitor control signal 128 exceeds (becomes greater than) the reference signal 130, the control signal 132 becomes active. The control signal 132, when active, causes (after a delay) the current signal 108 to decrease. As the current signal 108 decreases, the monitor control signal 128 decreases. As the monitor control signal 128 falls below (becomes less than) the reference signal 130, the control signal 132 becomes inactive. While the monitor control signal 128 is less than the reference signal 130, the control signal 132 is inactive.

FIG. 1C is a block diagram of the apparatus 100 shown in FIG. 1A including a block diagram of the circuit 110 and a schematic diagram of the monitor circuit 102, the reference circuit 104, and the control circuit 106 in accordance with some embodiments of the present invention. The monitor circuit 102, the reference circuit 104, the control circuit 106, and the circuit 110 are connected as shown in FIG. 1A and described above.

In operation, for signals transmitted among the circuit 110, the monitor circuit 102, the reference circuit 104, and the control circuit 106, the apparatus 100 shown in FIG. 1C functions substantially the same as the apparatus 100 shown in FIG. 1A. The current signal 108, the monitor control signal 128, the reference signal 130, and the control signal 132 operate substantially as shown in FIG. 1B.

The monitor circuit 102 includes a current mirror circuit 140, a transistor 142, the signal port 112, and the output port 114. The current mirror circuit 140 includes transistors 144 and 146. The transistor 144 includes a drain/source terminal 148, a drain/source terminal 150, and a gate terminal 152. The transistor 146 (diode connected) includes a drain/source terminal 154, a drain/source terminal 156, and a gate terminal 158. The transistor 142 (diode connected) includes a drain/source terminal 160, a drain/source terminal 162, and a gate terminal 164.

In the current mirror circuit 140, the drain/source terminal 148 of the transistor 144 is coupled to a supply potential 166. The drain/source terminal 150 is coupled to the output port 114. The drain/source terminal 154 of the transistor 146 is coupled to the supply potential 166. The drain/source terminal 156 is coupled to the gate terminal 158. The gate terminal 158 of the transistor 146 is coupled to the gate terminal 152 of the transistor 144.

In the monitor circuit 102, the drain/source terminal 160 and the gate terminal 164 of the transistor 142 are coupled to the output port 114. The drain/source terminal 162 is coupled to a supply potential 168. Hence, the transistor 142 is connected in series with the transistor 144 of the current mirror circuit 140. The drain/source terminal 156 of the transistor 146 in the current mirror circuit 140 is coupled to the signal port 112.

In operation, the current signal 108 is present at the signal port 112 of the monitor circuit 102 and flows in the transistor 146. The current signal 108 is mirrored in the transistor 144. The mirrored current signal (not shown) in the transistor 144 is converted to a voltage signal at the drain/source terminal 160 of the transistor 142, and the voltage signal is provided as the monitor control signal 128 at the output port 114.

The reference circuit 104 includes a current mirror circuit 170, a transistor 172, a current reference circuit 174, and the output port 116. The current mirror circuit 170 includes transistors 176 and 178. The transistor 176 includes a drain/source terminal 180, a drain/source terminal 182, and a gate terminal 184. The transistor 178 (diode connected) includes a drain/source terminal 186, a drain/source terminal 188, and a gate terminal 190. The transistor 172 (diode connected) includes a drain/source terminal 192, a drain/source terminal 194, and a gate terminal 196.

In the current mirror circuit 170, the drain/source terminal 180 of the transistor 176 is coupled to a supply potential 200. The drain/source terminal 182 is coupled to the output port 116. The drain/source terminal 186 of the transistor 178 is coupled to the supply potential 200. The drain/source terminal 188 is coupled to the gate terminal 190. The gate terminal 184 of the transistor 176 is coupled to the gate terminal 190 of the transistor 178.

In the reference circuit 104, the drain/source terminal 192 and the gate terminal 196 of the transistor 172 are coupled to the output port 116. The drain/source terminal 194 is coupled to a supply potential 202. Hence, the transistor 172 is connected in series with the transistor 176. The current reference circuit 174 includes a reference current port 203 and a supply port 205. The reference current port 203 is coupled to the drain/source terminal 188 of the transistor 178, and the supply port 205 is coupled to the supply potential 202. Hence, the current reference circuit 174 is connected in series with the transistor 178.

The current reference circuit 174 is not limited to a particular type of circuit. In some embodiments, the current reference circuit 174 is an active circuit that includes active elements, such as transistors. In other embodiments, the current reference circuit 174 is a resistor.

FIG. 1D is a block diagram of the current reference circuit 174, shown in FIG. 1C, in accordance with some embodiments of the present invention. The current reference circuit 174 includes current mirror circuits 204 and 206, transistors 208 and 210, bias circuits 212 and 214, a supply potential 216, the supply port 205, and the supply potential 202. The bias circuits 212 and 214 are coupled to the gates of the transistors 208 and 210, respectively. The transistors 208 and 210 are connected in series with the supply potential 216 and the current mirror circuit 204. A drain/source terminal of the transistor 210 is coupled to the current mirror circuit 206. The current mirror circuit 206 includes the reference current port 203.

FIG. 1E is a set of equations 222 for calculating a value of a difference current signal 224 in the current reference circuit 174 shown in Fig. ID. Referring to FIGS. 1D and 1E, equation (1) defines the difference current 224 in terms of electron mobility, oxide thickness, transistor threshold voltage, and parameters a and b. Equations (2) and (3) define parameters z1 and z2 for the transistors 208 and 210 in terms of the transistor channel lengths and widths. Equations (4) and (5) define a relationship between the threshold voltage of each of the transistors 208 and 210 and the gate-to-drain/source voltage of each of the transistors 208 and 210. Transistors 208 and 210 are sized in accordance with equations (2) and (3) and biased in accordance with equations (4) and (5) such that equations (6) and (7) are satisfied or equation (8) is satisfied to produce the difference current signal 224. The difference current signal 224 is a non-zero process-compensated current as described in U.S. Patent No. 6,346,803.

Referring again to FIG. 1D, in operation, the current reference circuit 174 provides a reference current signal 230 at the reference current port 203. The bias circuit 214 is set to generate the current signal 226 having a first value in the transistor 210. The bias circuit 212 is set to generate the current signal 228 having a second value in the transistor 208. The difference current signal 224 flows in the current mirror circuit 206 and has a value that is the difference between the first value and the second value. The difference current signal 224 is mirrored by the current mirror circuit 206 to provide the reference current signal 230 at the reference current port 203. The current reference circuit 174 has little variance over temperature and process changes. This permits establishment of a well-defined operation region for the reference circuit 104. A well-defined operation region reduces the probability of false alarms. In addition the current reference circuit 174 can be realized completely as a integrated circuit without need for external components, such as precision resistors.

In some embodiments, the bias circuits 212 and 214 are controlled by digital signals. For example, in some embodiments, the bias circuits 212 and 214 include a digital-to-analog converter (DAC) (not shown), such as a sixteen-bit DAC converter controlled by a sixteen-bit digital signal. In some embodiments, the bias circuits 212 and 214 receive a signal generated from a DAC.

Referring to FIG. 1C, in operation, the reference circuit 104 provides the reference signal 130 at the output port 116. The current reference circuit 174 generates the reference current signal 230. The reference current signal 230 is provided to the transistor 178 and is mirrored in the transistor 176. The mirrored current signal (not shown) in the transistor 176 is converted to a voltage signal at the drain/source terminal 192 of the transistor 172 and provided as the reference signal 130 at the output port 116.

The control circuit 106 includes a differential amplifier 232 and a transistor 234. In some embodiments, the differential amplifier 232 is a differential pair. The differential amplifier 232 is coupled to the input ports 118 and 120 and the transistor 234. The transistor 234 is serially connected between the output port 122 and a supply potential 236.

In operation, the control circuit 106 receives the reference signal 130 at the input port 118 and receives the monitor control signal 128 at the input port 120. If the monitor control signal 128 is greater than the reference signal 130, then the differential amplifier 232 turns the transistor 234 “on” to activate the control signal 132 at the output port 122 by coupling the supply potential 236 to the output port 122. If the monitor control signal 128 is less than the reference signal 130, then the differential amplifier 232 turns the transistor 234 “off” to deactivate the control signal 132 at the output port 122. With the control signal 132 deactivated, the signal level at the control port 124 is determined by the circuit 110.

FIG. 1F is a block diagram of the circuit 110 shown in FIG. 1A and FIG. 1C in accordance with some embodiments of the present invention. The circuit 110 includes a voltage regulator 238, a transistor 240, and a connective element 242. The voltage regulator 238 is not limited to a particular type of voltage regulator. In some embodiments, the voltage regulator 238 includes the voltage regulator described in U.S. patent application having Ser. No. 10/334,505 and entitled On Die Voltage Regulator. In some embodiments, the voltage regulator 238 includes the transistor 240. In some embodiments, the voltage regulator 238 includes the control port 124, a power control signal port 244, and a power port 246. The transistor 240 includes a gate terminal 248, a drain/source terminal 250 and a drain/source terminal 252. The gate terminal 248 is coupled to the power control signal port 244, the drain/source terminal 250 is coupled to the signal port 126 (shown in FIGS. 1A and 1C), and the drain/source terminal 252 is coupled to the connective element 242. The transistor 240 is sized to provide a current proportional to the current provided at the connective element 242 by the voltage regulator 238. In some embodiments, the current provided by the transistor 240 is less than the current delivered at the connective element 242 by the voltage regulator 238. The connective element 242 is not limited to a particular type of connective element. Exemplary connective elements suitable for use in connection with the circuit 110 include module pins, flip chip connections, and bonding pads.

In operation, a load (not shown) is coupled to the connective element 242. The voltage regulator 238 attempts to provide a substantially constant voltage at the connective element 242. Thus, the voltage regulator 238 attempts to deliver the current required to maintain a constant voltage at the connective element 242. Referring to FIG. 1C, the apparatus 100 receives the monitor control signal 128 from the monitor circuit 102. If the monitor control signal 128 exceeds the value of the reference signal 130, then the apparatus 100 activates the control signal 132 at the control port 124. Activation of the control signal 132 causes the current delivered by the voltage regulator 238 (shown in FIG. 1F) to the connective element 242 (shown in FIG. 1F) to be reduced. Thus, if the load demands a current that could damage the circuits included in the voltage regulator 238, then the apparatus 100 can provide protection against such damage. For example, if the connective element 242 is shorted to ground, then the apparatus 100 can prevent destruction of the voltage regulator 238.

FIG. 1G is a schematic diagram of the voltage regulator 238, shown in a block diagram in FIG. 1F, coupled to the connective element 242 in accordance with some embodiments of the present invention. The voltage regulator 238 includes a divider circuit 254, a differential amplifier 256, and a transistor 258. The divider circuit 254 includes a signal port 260. The differential amplifier 256 includes an inverting input terminal 262, a non-inverting input terminal 264, and an output terminal 266. The transistor 258 includes a gate terminal 268, a drain/source terminal 270, and a drain/source terminal 272. The divider circuit 254 is connected in series between a supply potential 274 and a supply potential 276. The signal port 260 of the divider circuit 254 is coupled to the non-inverting input terminal 264 of the differential amplifier 256. The output terminal 266 of the differential amplifier 256 is coupled to the gate terminal 268 of the transistor 258. The drain/source terminal 270 of the transistor 258 is coupled to the supply potential 274. The drain/source terminal 272 of the transistor 258 is coupled to the connective element 242 and to the inverting input terminal 262 of the differential amplifier 256.

In operation, the differential amplifier 256 receives a reference signal from the signal port 260 of the divider circuit 254 and a negative feedback signal from the connective element 242. The differential amplifier 256 provides a signal at the output terminal 266 that drives the gate terminal 268 of the transistor 258 to control the voltage level at the connective element 242 to the voltage level at the signal port 260 of the divider circuit 254.

FIG. 1H is a block diagram of a system 280 including the apparatus 100, shown in FIG. 1A, including the circuit 110 shown in FIG. 1A, in accordance with some embodiments of the present invention. In some embodiments, the system 280 is formed on a substrate 282. Exemplary substrate materials suitable for use in connection with the fabrication of the system 280 include silicon, germanium, gallium arsenide, and silicon-on-sapphire. A substrate on which circuits are formed is sometimes referred to as a die. In some embodiments, the system 280 is formed on a die, such as a silicon die. In some embodiments, the circuit 110 includes a processor 284. Exemplary processors suitable for use in connection with the fabrication of the system 280 include complex instruction computing system processors, reduced instruction set processors, very long instruction word processors, and digital signal processors. In some embodiments, the system 280 includes a flash memory 286 formed on the substrate 282 and coupled to the processor 284. A flash memory is a non-volatile semiconductor memory. In some embodiments, the circuit 110 is coupled to a transceiver (digital or analog) 288 formed on the substrate 282. Exemplary transceivers include cell phone transceivers, short-wave radio transceivers, television transceivers, and mobile computing platform transceivers. A transceiver includes both a receiver and a transmitter. In some embodiments, the transceiver 288 is coupled to an antenna 290 formed on the substrate 282. In some embodiments, the transceiver 288 is coupled to an antenna 292 formed external to the substrate. An antenna is a device that transforms electromagnetic waves into electronic signals suitable for processing with transistor circuits or that transforms electronic signals into electromagnetic waves.

FIG. 1I is a flow diagram of a method 294 for controlling a current in accordance with some embodiments of the present invention. The method 294 includes generating a reference current (block 296), generating a first current in a circuit (block 298), generating a second current related to the first current (block 300), and reducing the first current when the second current is greater than the reference current (block 302). In some embodiments, the method 294 further includes generating a reference voltage from the reference current. In some embodiments, generating the reference voltage from the reference current includes mirroring the reference current to generate the reference voltage. In some embodiments, the method includes generating a voltage from the second current. In some embodiments, generating the voltage from the second current includes mirroring the second current to generate the voltage. In some embodiments, the method further includes comparing the reference voltage to the voltage to generate a control signal to control the first current.

Those skilled in the art will appreciate that a variety of power supply configurations can be used to provide power to the circuits described above. The various references to “supply potential” in the description provided above is not intended to limit the operation of the circuits in any way. Those skilled in the art will appreciate that the circuits described above can operate from many different “supply potentials” and “supply potential” configurations.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the invention. The various appearances of “an embodiment,” “one embodiment,” or “some embodiments” are not necessarily all referring to the same embodiments.

If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although specific embodiments have been described and illustrated herein, it will be appreciated by those skilled in the art, having the benefit of the present disclosure, that any arrangement which is intended to achieve the same purpose may be substituted for a specific embodiment shown. This application is intended to cover any adaptations or variations of the present invention. Therefore, it is intended that this invention be limited only by the claims and the equivalents thereof.

1. An apparatus comprising:
a first circuit to monitor a current in a circuit;
a second circuit to produce a reference current; and
a control circuit coupled to the first circuit and the second circuit, the control circuit to process a first signal received from the first circuit and a second signal received from the second circuit and to provide a control signal to the circuit to control the current.

2. The apparatus of claim 1, wherein the first circuit comprises a first current mirror circuit.

3. The apparatus of claim 2, wherein the second circuit comprises a second current mirror circuit.

4. The apparatus of claim 3, wherein the control circuit comprises a differential amplifier.

5. The apparatus of claim 4, wherein the first circuit monitors the current by monitoring a further current proportional to the current.

6. The apparatus of claim 1, wherein the control signal causes the current to decrease when the current changes from being greater than the reference current to being less than the reference current.

7. The apparatus of claim 1, wherein the control signal causes the current to increase when the current becomes less than the reference current.

8. The apparatus of claim 7, wherein at least one of the first circuit, the second circuit and the control circuit are formed on a substrate.

9. The apparatus of claim 8, wherein the substrate comprises a semiconductor.

10. A system comprising:
a first circuit to monitor a current in a circuit;
a flash memory circuit coupled to the circuit;
a second circuit to produce a reference current; and
a control circuit coupled to the first circuit and the second circuit, the control circuit to process a first signal received from the first circuit and a second signal received from the second circuit and provide a control signal to the circuit to control the current.

11. The system of claim 10, wherein the circuit comprises a voltage regulator.

12. The system of claim 11, wherein the voltage regulator includes a first transistor and a second transistor, the second transistor to conduct a fraction of the current in the first transistor.

13. The system of claim 12, wherein the first circuit includes a first current mirror circuit and the second circuit includes a second current mirror circuit.

14. The system of claim 13, wherein the control circuit includes a differential pair.

15. The system of claim 10, further comprising a transceiver coupled to the circuit.

16. The system of claim 15, wherein the transceiver is coupled to an antenna.

17. The system of claim 16, wherein the antenna comprises an external antenna.

18. The system of claim 10, wherein the first circuit provides a voltage signal to the control circuit.

19. The system of claim 18, wherein the second circuit provides a voltage reference signal to the control circuit.

20. A method comprising:
generating a reference current;
generating a first current in a circuit;
generating a second current related to the first current; and
reducing the first current when the second current is greater than the reference current.

21. The method of claim 20, further comprising generating a reference voltage from the reference current.

22. The method of claim 21, wherein generating the reference voltage from the reference current comprises mirroring the reference current to generate the reference voltage.

23. The method of claim 21, further comprising generating a voltage from the second current.

24. The method of claim 23, wherein generating the voltage from the second current comprises mirroring the second current to generate the voltage.

25. The method of claim 23, further comprising comparing the reference voltage to the voltage to generate a control signal to control the first current.
